(19) United States
(12) Patent Application Publication
(10) Pub. No.: US 2019/0244094 A1
(43) Pub. Date: Aug. 8, 2019

(54) MACHINE LEARNING DRIVEN DATA MANAGEMENT

(71) Applicant: SAP SE, Walldorf (DE)

(72) Inventor: Hans-Martin Ramsl, Mannheim (DE)

(21) Appl. No.: 15/890,184

(22) Filed: Feb. 6, 2018

(51) Int. Cl. G06N 3/08; G06F 9/451; G06N 3/04; G06F 15/18; G06F 17/30; G06K 9/62

(52) U.S. Cl. CPC G06N 3/08; G06F 9/453; G06K 9/6256; G06F 15/18; G06F 17/3061; G06N 3/04

(57) ABSTRACT

A system for machine learning driven data management is provided. In some implementations, the system performs operations including receiving, by a neural network, first and second textual data associated with a first item and a second item. The operations further include converting, by the neural network, the first and second textual data to a first vector and a second vector. The operations further include determining, by the neural network, whether the first item and the second item satisfy, based on a comparison of the first vector with the second vector, a similarity threshold. The operations further include selecting, by the neural network and in response to satisfaction of the similarity threshold, one of the first item and the second item, the selecting based on a selection criteria. The operations further include providing, by the neural network, a recommendation on a user interface regarding the selected first item or second item.

### TECHNICAL FIELD

The subject matter described herein relates generally to database processing and, more specifically, to the use of machine learning in the management of data and databases.

### BACKGROUND

Machine learning may give computers the ability to learn without explicit programming. A common machine learning approach is to use an artificial neural network. An artificial neural network is a simulation of the biological neural network of the human brain. The artificial neural network accepts several inputs, performs a series of operations on the inputs, and produces one or more outputs. A typical artificial neural network consists of a number of connected artificial neurons or processing nodes, and a learning algorithm. Artificial neurons and connections typically have a weight that adjusts as learning proceeds. Artificial neurons are often organized in layers. Through the weighted connections, a neuron in a layer receives inputs from those connected to it in a previous layer, and transfers output to those connected to it in the next layer. Different layers may perform different kinds of transformations on their inputs.

### SUMMARY

Systems, methods, and articles of manufacture, including computer program products, are provided for data management. In one aspect, there is provided a system. The system may include at least one data processor and at least one memory. The at least one memory may store instructions that result in operations when executed by the at least one data processor. The operations may include receiving, by a neural network, first textual data associated with a first item and second textual data associated with a second item. The operations further include converting, by the neural network, the first textual data to a first vector and the second textual data to a second vector, the first vector indicating one or more words associated with the first item, the second vector indicating one or more words associated with the second item. The operations further include determining, by the neural network, whether the first item and the second item satisfy, based on a comparison of the first vector with the second vector, a similarity threshold. The operations further include selecting, by the neural network and in response to satisfaction of the similarity threshold, one of the first item and the second item, the selecting based on a selection criteria. The operations further include providing, by the neural network, a recommendation on a user interface regarding the selected first item or second item.

In another aspect, there is provided a method. The method includes receiving, by a neural network, first textual data associated with a first item and second textual data associated with a second item. The method further includes converting, by the neural network, the first textual data to a first vector and the second textual data to a second vector, the first vector indicating one or more words associated with the first item, the second vector indicating one or more words associated with the second item. The method further includes determining, by the neural network, whether the first item and the second item satisfy, based on a comparison of the first vector with the second vector, a similarity threshold. The method further includes selecting, by the neural network and in response to satisfaction of the similarity threshold, one of the first item and the second item, the selecting based on a selection criteria. The method further includes providing, by the neural network, a recommendation on a user interface regarding the selected first item or second item.

In another aspect, there is provided a non-transitory computer program product storing instructions which, when executed by at least one data processor, causes operations which include receiving, by a neural network, first textual data associated with a first item and second textual data associated with a second item. The operations further include converting, by the neural network, the first textual data to a first vector and the second textual data to a second vector, the first vector indicating one or more words associated with the first item, the second vector indicating one or more words associated with the second item. The operations further include determining, by the neural network, whether the first item and the second item satisfy, based on a comparison of the first vector with the second vector, a similarity threshold. The operations further include selecting, by the neural network and in response to satisfaction of the similarity threshold, one of the first item and the second item, the selecting based on a selection criteria. The operations further include providing, by the neural network, a recommendation on a user interface regarding the selected first item or second item.

In some variations, one or more features disclosed herein including the following features may optionally be included in any feasible combination. In some aspects, the receiving and the converting are performed by an input layer of the neural network, the determining is performed by an embedding layer of the neural network, and the selecting and the providing are performed by a comparison layer of the neural network. In some implementations, the operations may include preprocessing the first textual data and/or the second textual data to remove at least a portion of the first textual data and/or the second textual data. In some implementations, the operations may include comparing, in response to receiving the first and the second vectors, the one or more words associated with the first item and the one or more words associated with the second item. In some aspects, the operations may include determining, based on the comparing the one or more words associated with the first item and the one or more words associated with the second item, a degree of similarity between the first item and the second item, wherein the similarity threshold comprises a threshold degree of similarity value. In some aspects, the operations may include correlating a first weighted score with the first item and a second weighted score with the second item, the selection criteria comprising a weighted score value and selecting the first item, when the first weighted score is higher than the second weighted score.

Implementations of the current subject matter may include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which may include a non-transitory computer-readable or machine-readable storage medium, may include, encode, store, or the like one or more programs that cause one or more processors to perform one or more of the operations described herein. Computer implemented methods consistent with one or more implementations of the current subject matter may be implemented by one or more data processors residing in a single computing system or multiple computing systems. Such multiple computing systems may be connected and may exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a diagram illustrating a system, in accordance with some example implementations;

FIG. 2A depicts a diagram of a system illustrating layers of a neural network, in accordance with some example implementations;

FIG. 2B depicts a diagram of a data exchange among an input layer, an embedding layer, and a comparison layer, in accordance with some example implementations;

FIG. 3 depicts a flowchart illustrating a process for machine learning based data management, in accordance with some example implementations;

FIG. 4 depicts a block diagram illustrating a computing system, in accordance with some example implementations.

When practical, similar reference numbers denote similar structures, features, or elements.

### DETAILED DESCRIPTION

Large organizations and companies receive, manage, and/or control increasing amounts of data. For example, data portfolios in large corporations often grow with high dynamics and high volume. Data items often have duplicates or parallel developments which may make one item superfluous. Portfolio and data managers often manage large amounts of data and the managers may lose the overview and/or details of the data. Further, new items may come in to the organization and managers may have to phase out of old items and update the portfolio.

In some implementations, machine learning models, such as neural networks, may be trained to analyze data associated with the items in large portfolios to determine which items are similar, non-performing, resource intensive, and/or the like. Rather than mere finding similar or duplicative items in a portfolio, the neural network may be trained to correlate a defined selection criteria to the similar items to determine which one or more items of the similar items should remain in the portfolio and which items should be pruned. In response to such analysis, the neural network may remove and/or provide a recommendation to a user to remove and/or reduce a number of items and/or data in a portfolio and/or database. For instance, a data management neural network may classify a data item by at least processing a textual document description associated with the data item through a plurality of layers including, for example, one or more input layers, embedding layers, and/or comparison/output layers.

The input layer may transform words of text document into a numerical vector, the embedding layer may compare the numerical vectors to identify similar items, and the comparison layer may correlate the identified similar items with a selection criterion to determine which of the similar items should remain in the portfolio and/or database and which item(s) should be pruned or removed from the portfolio and/or database. Use of the neural network to perform these tasks can beneficially reduce not only the amount of data stored in a portfolio but also efficiently prune duplicative, insignificant, and/or irrelevant data. Additionally, accuracy of recommendations provided by the neural network can improve as more data is received and as users confirm or modify the recommendations.

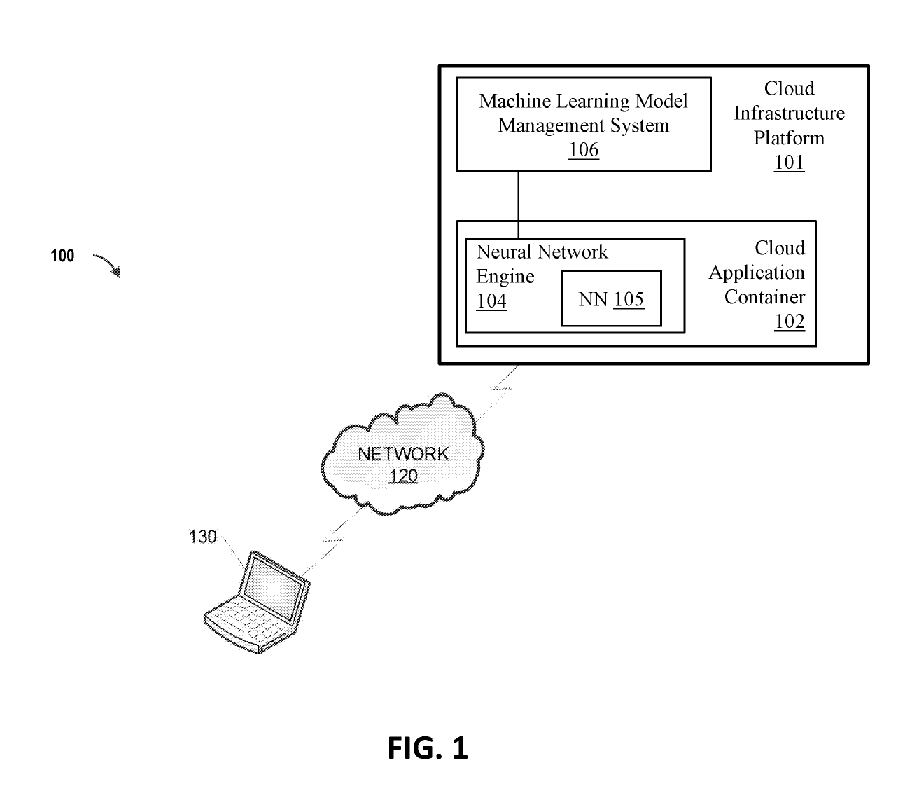

FIG. 1 depicts a diagram illustrating a system 100, in accordance with some example implementations. As shown in FIG. 1, the network environment 100 includes a client device 130 communicating over a network 120 with a cloud infrastructure platform 101. The 120 may be a wide area network (WAN), a local area network (LAN), and/or the Internet. In some aspects, the cloud infrastructure platform 101 may include a cloud application container 102, a neural network engine 104 which contains a neural network (NN) 105, and a machine learning model management system 106.

In some implementations, the cloud application container 102 may run an application program code for implementing the neural network 105. The neural network engine 104 may be configured to perform data processing and analysis based on the inputs and outputs of the neural network 105. For example, the neural network 105 may be configured to implement one or more machine learning models. After a model is trained using the neural network 105, the neural network engine 104 may process the results and transmit a version of the trained model to the machine learning (ML) model management system 106. The ML model management system 106 may then store the version of the trained model, as well as other versions of models. In some aspects, the cloud infrastructure platform 101 may track different versions of a model over time and analyze performance of the different versions.

In some example embodiments, the client device 130 may provide a user interface for interacting with one or more components of the cloud infrastructure platform 101. For example, a user may provide, via the client device 130, one or more training sets, validation sets, and/or production sets for processing by the neural network 105. Alternatively and/or additionally, the user may provide, via the client device 130, one or more configurations for the neural network 105 including, for example, parameters and textual definitions used by the neural network 105 when processing the one or more training sets, validation sets, and/or production sets. The user may further receive, via the client device 130, outputs from the neural network 105 including, for example, a result of the processing of the one or more training sets, validation sets, and/or production sets.

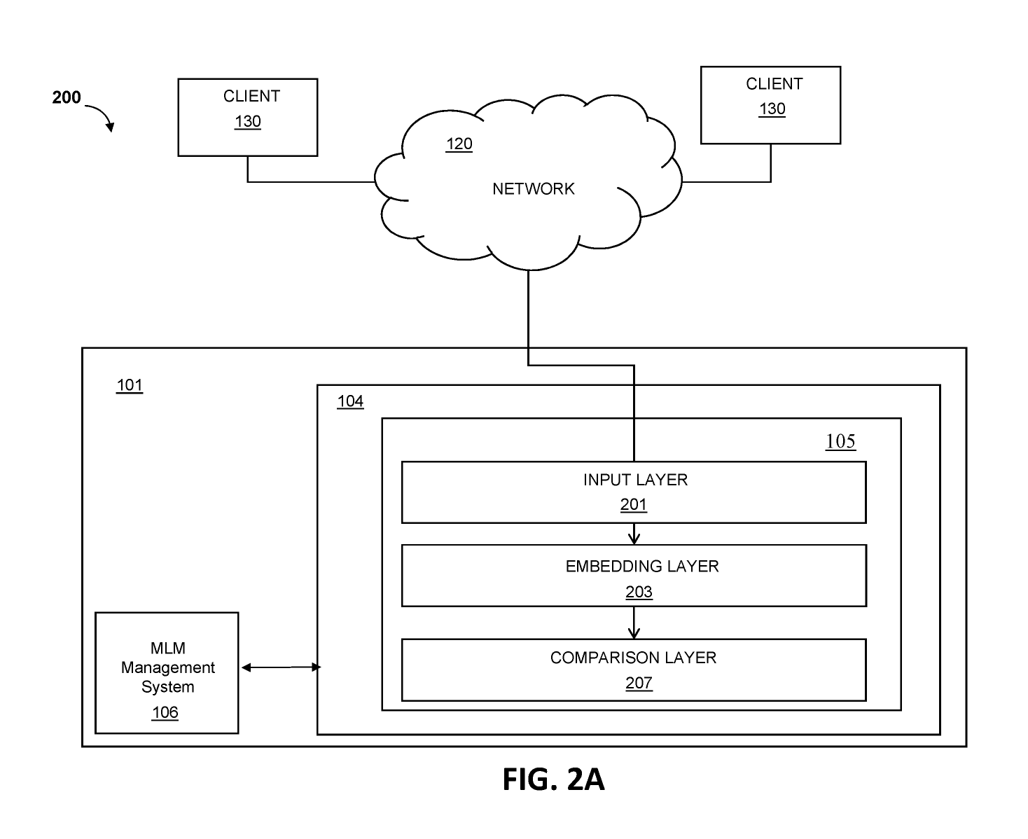

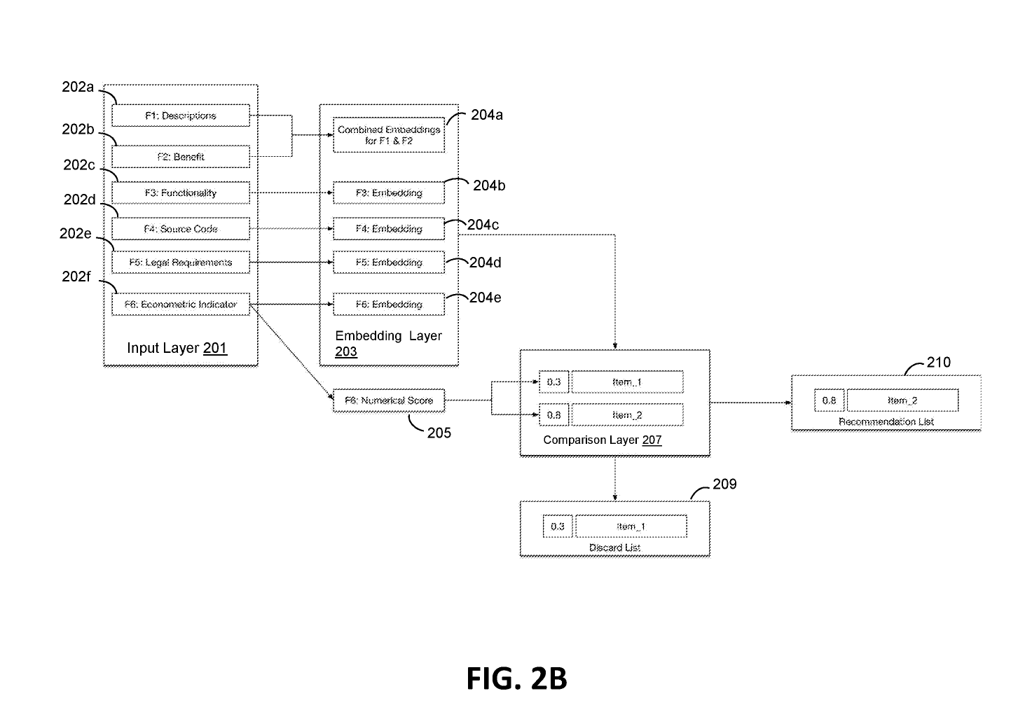

FIG. 2A depicts a diagram of a system 200 illustrating layers of the neural network 105, in accordance with some example implementations. As shown in FIG. 2A, client devices 130 communicate with the neural network 105 over the network 120. The neural network 105 may include an input layer 201, an embedding layer 203, and a comparison layer 207. In some aspects, the input layer 201 may be defined as one or more layers receiving unstructured text data and converting the unstructured text into numerical representations so that each word is represented by a unique numerical representation. In some aspects, the embedding layer 203 may be defined as one or more layers that processes numerical input data, such as vectors, to determine similarities between numerical representations of words. The embedding layer 203 may output two or more items determined to be similar to each other. In some implementations, the comparing layer 207 may defined as one or more layers that receives a plurality of numerical representations of similar items, such as vectors, and correlates the similar items with a normalized score to output one or more of the similar items that should be removed from or kept in a portfolio. In some aspects, the normalized score is based on one or more performance metrics associated with the similar items.

In some implementations, the client devices 130 may transmit data to the input layer 201. For example, the client devices 130 may transmit textual data regarding items in a data management portfolio to the input layer 201. In some aspects, the text data received at the input layer may be preprocessed and/or cleaned in order to create more significant representations and reduce the noise in the vectors to be generated by the input layer 201. The preprocessing may include removing certain insignificant words, such as “and,” “the,” “or,” and the like. The preprocessing may also include tokenization and/or normalization to avoid duplications from singular and plural words.

Once the text data inputs are received at the input layer 201, the input layer 201 may then convert the text data to numerical representations of the text, such as a vector. In some aspects, the conversion from text to vector is accomplished using word embeddings. In some aspects, the word embeddings utilize trained models to generate vectors that also indicate a probability of other words surrounding a given word in a document, a probability of a previous or next word to the given word, and/or the like. In some implementations, the trained model may include a skip-gram model, a count vector model, a continuous bag of words (CBOW) model, and/or the like. Converting text to numerical vectors may allow the embedding layer 203 to apply machine learning techniques to the numerical vectors. After conversion, the input layer 201 may then communicate the numerical representations to the embedding layer 203.

The embedding layer 203 may receive the inputs from the input layer 201 in a vector format and perform further analysis on the vectors. In some implementations, the embedding layer 203 may analyze the vectors to identify two or more items of a data portfolio that are similar. To determine whether two or more items are similar, the embedding layer 203 may compare words associated with each of the two or more items. For example, a first item vector may indicate that there is a high probability that the first item is associated with the words “blue,” “toy,” “electronic,” and “handheld.” A second item vector may also indicate that there is a high probability that the second item is associated with some or all of the same words as the first item. The embedding layer 203 may determine whether those similar word associations and/or other factors, are sufficient to identify the first item and second item as similar items. In some aspects, the identification may be based on the first item and second item satisfying a similarity threshold. The embedding layer 203 may then transmit the identified similar items to the comparison layer 207.

The comparison layer 207 may perform analysis on the similar items received from the embedding layer 203 to determine which items should be pruned from the data management database/portfolio. The comparison layer 207 may correlate the similar items with a selection criteria and/or performance metrics to determine which items should remain or be removed from the data management database/portfolio. Data related to each of the layers 201, 203, and/or 207 of the neural network 105 may be transmitted to the ML model management system 106 for storage and/or later access.

FIG. 2B depicts a diagram of a data exchange among the input layer 201, the embedding layer 203, and the comparison layer 207, in accordance with some implementations. As shown in FIG. 2B, the input layer 201 may receive inputs 202. In some implementations, the inputs 202 may include different item characteristics. As shown in FIG. 2B, the inputs 202 include item descriptions 202a, item benefits 202b, item functionality 202c, source code associated with the item 202d, item legal requirements 202e, item econometric indicators or key performance indicators (KPI) 202f, or any other data input. In some aspects, the input layer 201 may receive the inputs 202 from one or more client devices 130 over the network 120. The inputs 202 may be preprocessed for ease of conversion or may be unprocessed.

The input layer 201 may convert text data inputs 202 into numerical representations using word embeddings. In some implementations, the numerical representation includes as a vector space representation. In some aspects, the vector space representation is a high dimensional space comprising more than three dimensions. In some implementations, the method for word embedding used by the input layer 201 uses unstructured data from a catalog containing plain text descriptions, such as inputs 202a-202e, as a textual corpus. In some aspects, the catalog may be pre-programmed. Based on the corpus, a word embedding model may be trained. The word embedding model may learn and improve weights given to certain words based on the inputs 202 received. In some aspects, the similarities may be determined based on the words surrounding a given word or phrase, such as the words immediately preceding or following the given word. For example, if multiple inputs 202a include the words “blue” and “box” next to each other the probability that that two words will be associated with one another may increase. In some aspects, the word embedding model used may be the skip-gram model, however, other word embedding models may also be used (e.g., CBOW, count vectors, TF-IDF, co-occurrence matrix, etc.).

Upon receiving the numerical representations, such as vectors, from the input layer 201, the embedding layer 203 may perform data analysis on the vectors to determine similarities between items in a data portfolio based on the vectors. As shown in FIG. 2B, the embedding layer 203 may include a word embedding component 204 configured to receive the vectors related to one or more of the item characteristics, such as inputs 202, for different items of the portfolio. In some implementations, in order to make the computation more efficient, the embedding layer 203 and/or the word embedding component 204 (204a-204e) may perform a dimensionality reduction of the word embeddings received from the input layer 201 to both reduce hardware requirements (RAM) and speed up the computation to provide recommendations in shorter timeframes.

The embedding layer 203 and/or the word embedding component 204 may compare vectors of different items and determine whether the vectors indicate that the different items are similar to each other. In some aspects, the embedding layer 203 and/or the word embedding component 204 may be configured to use a machine learning model to perform the analysis for determining the similarities between different items. The embedding layer 203 may learn based on a trained machine learning model and/or from iterations based additional inputs 202 from different data sources.

In some aspects, the word embedding components 204 may receive two or more vectors representing different item characteristics, such as vectors representing item descriptions 202a and item benefits 202b as shown by word embedding component 204a in FIG. 2B, to perform the similarity analysis. In some implementations, the embedding layer 203 and/or the word embedding component 204 may determine similarity by computing the cosine between the different vectors or by any other comparison algorithm. Based on comparisons of two or more vectors representing one or more inputs 202, the embedding layer 203 may output two or more similar items to the comparison layer 207.

In some implementations, the comparison layer 207 may correlate the similar items generated from the embedding layer 203 with a numerical score 205 to determine which of the similar items should be pruned or kept in the data portfolio. In some aspects, the numerical score 205 is provided by input 202f, the F6: econometric KPI, a quantitative indicator. The KPI numerical score 205 may be based on the item sales figures, cost of manufacture, sales growth, or other selection criteria. In some implementations, the selection criteria may include user selected criteria such as a minimum sales revenue, a target market, cost of goods sold, and/or the like. The selection criteria may comprise a numerical value that indicates a performance of the item, such as days to complete manufacture, sales volume of the item, speed metrics, efficiency metrics, and/or the like. In some aspects, the KPI numerical score 205 may be a weighted and/or a normalized score such that the value of the KPI numerical score 205 is in the range 0<KPI<1, where 1 is the best score. In the example of FIG. 2B, the embedding layer 203, using the machine learning model and based on the vectors from the word embedding components 204, identifies two similar items (Item_1 and Item_2). The embedding layer 203 may send these two similar items to the comparison layer 207 for further analysis.

The comparison layer 207 may compare the two items and, based on a similarity analysis and based on the econometric KPI numerical score 205, the comparison layer 207 may determine a recommendation for which item should be removed and which one should be kept. In some aspects, the similarity analysis may return a normalized degree of similarity between 0 and 1, where 0 means no similarity and 1 means identical similarity. In some implementations, the higher the normalized degree, the higher the similarity. In some aspects, the comparison layer 207 may define which similarity threshold value should be used. For example, the similarity threshold may include a threshold degree of similarity, such as a degree of similarity higher than 0.75. In some aspects, the degree of similarity can be based on a Euclidean distance, cosine similarity, and/or any other measure for similarity between the vectors associated with the items. As shown in FIG. 2B, the comparison layer 207 has performed an analysis on Item_1 and Item_2 and determined that the two items satisfy the similarity threshold.

As further shown, the KPI numerical score 205 associated with Item_1 is 0.3 and the KPI numerical score 205 associated with Item_2 is 0.8. Since the two items are similar and thus competing, only the item with the better performance (better KPI numerical score 205) should be relevant while the other may be pruned. In FIG. 2B, the comparison layer 207 determines that Item_1 should be sent to the discard list 209. In some aspects, the discard list 209 may include a folder or file in the database 214 for deletion. The discard list 209 may also include a user interface configured to display the Item_1 to a user to confirm that the item should be discarded. The comparison layer 207 may also determine that Item_2 should be kept based at least in part on the KPI numerical score 205 and transmit Item_2 to a recommendation list 210. In some aspects, the recommendation list 210 may include a folder or file in the database 214 for storage or implementation. The recommendation list 210 may also include a user interface configured to display the Item_2 to a user to confirm that the item should be kept.

In some implementations, classifying, by the embedding layer 203, an item as similar to another item based on numerical vectors generated in the input layer 201 and the analysis performed in the comparison layer 207 may allow the cloud application container 102 and/or the neural network 105 to identify duplicative and/or obsolete data items which may effective reduce data items stored in a database or data portfolio. Such reduction of data items may allow for faster querying and data processing of the remaining items. The reduction may also result in more relevant data in the portfolio. The neural network 105 may also identify data items that require more resources and/or attention and provide recommendations for such items.

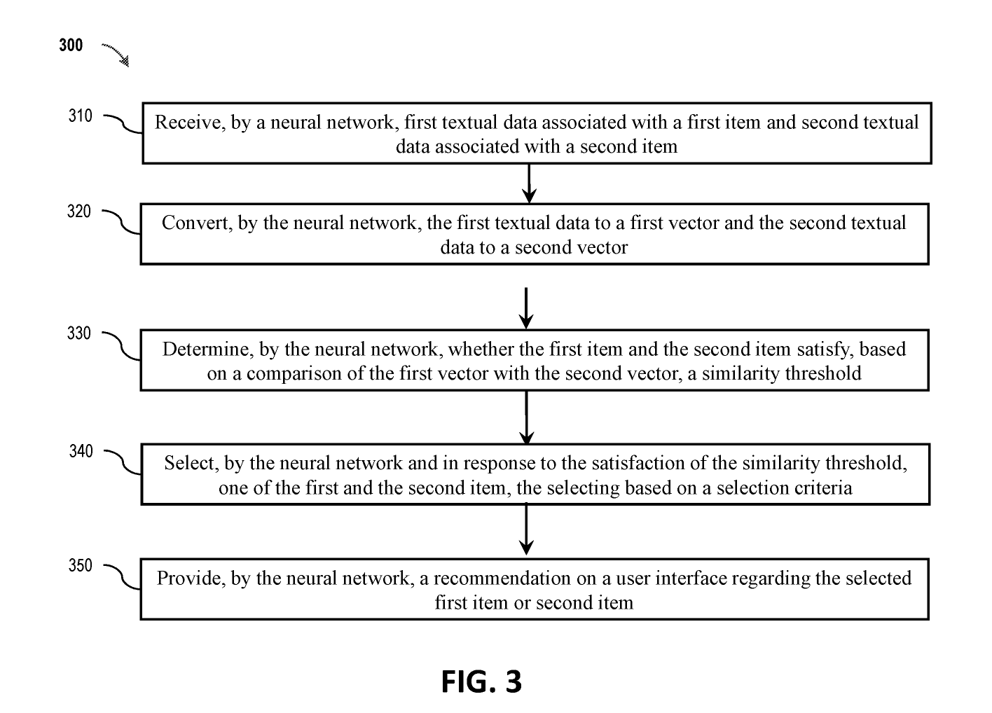

FIG. 3 depicts a flowchart illustrating a process 300 for machine learning based data management, in accordance with some example implementations. Referring to FIGS. 1, 2, and 4, the process 300 may be performed by a computing apparatus such as, for example, the neural network engine 110, the client device 130, the input layer 201, the embedding layer 203, the comparison layer 207, and/or the computing apparatus 400.

At operational block 310, the apparatus 400, for example, can receive, by a neural network, first textual data associated with a first item and second textual data associated with a second item. At operational block 320, the apparatus 400, for example, can convert, by the neural network, the first textual data to a first vector and the second textual data to a second vector. In some aspects, the first vector indicates one or more words associated with the first item and the second vector indicates one or more words associated with the second item. At operational block 330, the apparatus 400, for example, can determine, by the neural network, whether the first item and the second item satisfy, based on a comparison of the first vector with the second vector, a similarity threshold. At operational block 340, the apparatus 400, for example, can select, by the neural network and in response to satisfaction of the similarity threshold, one of the first item and the second item, the selecting based on a selection criteria. At operational block 350, the apparatus 400, for example, can provide, by the neural network, a recommendation on a user interface regarding the selected first item or second item.

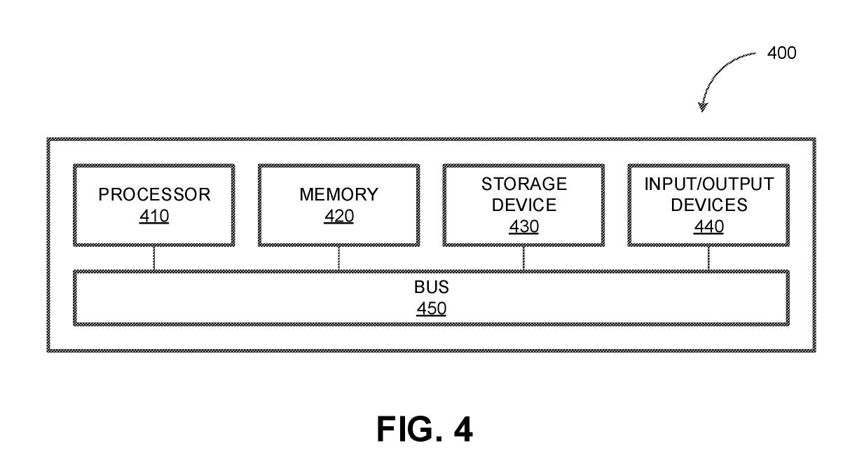

FIG. 4 depicts a block diagram illustrating a computing apparatus 400 consistent with implementations of the current subject matter. Referring to FIGS. 1-3, the computing apparatus 400 may be used to implement the neural network engine 110, the client device 130, the input layer 201, the embedding layer 203, the comparison layer 207, and/or the process 300.

As shown in FIG. 4, the computing apparatus 400 may include a processor 410, a memory 420, a storage device 430, and input/output devices 440. The processor 410, the memory 420, the storage device 430, and the input/output devices 440 may be interconnected via a system bus 450. The processor 410 is capable of processing instructions for execution within the computing apparatus 400. Such executed instructions may implement one or more components of, for example, the neural network engine 110, the client device 130, the input layer 201, the embedding layer 203, and/or the comparison layer 207. In some example implementations, the processor 410 may be a single-threaded processor. Alternately, the processor 410 may be a multi-threaded processor. In some aspects, the processor 410 includes a graphical processing unit (GPU) in order to handle the high computations of word embeddings in the word embedding layer 203 and/or word embedding components 204. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing apparatus 400. The memory 420 may store data structures representing configuration object databases, for example. The storage device 430 is capable of providing persistent storage for the computing apparatus 400. The storage device 430 may be a floppy disk device, a hard disk device, an optical disk device, or a tape device, or other suitable persistent storage means. The input/output device 440 provides input/output operations for the computing apparatus 400. In some example implementations, the input/output device 440 includes a keyboard and/or pointing device. In various implementations, the input/output device 440 includes a display unit for displaying graphical user interfaces.

According to some example implementations, the input/output device 440 may provide input/output operations for a network device. For example, the input/output device 440 may include Ethernet ports or other networking ports to communicate with one or more wired and/or wireless networks (e.g., a local area network (LAN), a wide area network (WAN), the Internet). The input/output device 440 may include one or more antennas for communication over the network 120 with the client device 130 and/or the cloud infrastructure platform 101.

In some example implementations, the computing apparatus 400 may be used to execute various interactive computer software applications that may be used for organization, analysis and/or storage of data in various formats. Alternatively, the computing apparatus 400 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing products and/or functionalities. Upon activation within the applications, the functionalities may be used to generate the user interface provided via the input/output device 440. The user interface may be generated and presented to a user by the computing apparatus 400 (e.g., on a computer screen monitor, etc.).

Additional applications of the subject matter herein be in the area of library sciences where a librarian is supported by the system in the process of procurement of new books: there might be similar books (similar topic, similar quality, similar scope) that differ in their procurement cost. The system may then recommend the more low-cost exemplar.

One or more aspects or features of the subject matter described herein may be realized in digital electronic circuitry, integrated circuitry, specially designed ASICs, field programmable gate arrays (FPGAs) computer hardware, firmware, software, and/or combinations thereof. These various aspects or features may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which may also be referred to as programs, software, software applications, applications, components, or code, include machine instructions for a programmable processor, and may be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example, as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein may be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system, comprising:
at least one data processor; and
at least one memory storing instructions which, when executed by the at least one data processor, result in operations comprising:
receiving, by a neural network, first textual data associated with a first item and second textual data associated with a second item;
converting, by the neural network, the first textual data to a first vector and the second textual data to a second vector, the first vector indicating one or more words associated with the first item, the second vector indicating one or more words associated with the second item;
determining, by the neural network, whether the first item and the second item satisfy, based on a comparison of the first vector with the second vector, a similarity threshold;
selecting, by the neural network and in response to satisfaction of the similarity threshold, one of the first item and the second item, the selecting based on a selection criteria; and
providing, by the neural network, a recommendation on a user interface regarding the selected first item or second item.

2. The system of claim 1, wherein the receiving and the converting are performed by an input layer of the neural network, wherein the determining is performed by an embedding layer of the neural network, and wherein the selecting and the providing are performed by a comparison layer of the neural network.

3. The system of claim 1, wherein the operations further comprise preprocessing the first textual data and/or the second textual data to remove at least a portion of the first textual data and/or the second textual data.

4. The system of claim 1, wherein the converting comprises training a word embedding model and converting the first textual data to the first vector and the second textual data to the second vector using the trained word embedding model.

5. The system of claim 4, wherein the word embedding model comprises a skip-gram model.

6. The system of claim 1, wherein the determining comprises:
comparing, in response to receiving the first and the second vectors, the one or more words associated with the first item and the one or more words associated with the second item; and
determining, based on the comparing the one or more words associated with the first item and the one or more words associated with the second item, a degree of similarity between the first item and the second item, wherein the similarity threshold comprises a threshold degree of similarity value.

7. The system of claim 1, wherein the selection criteria comprises user-selected criteria.

8. The system of claim 1, wherein the selecting comprises:
correlating a first weighted score with the first item and a second weighted score with the second item, the selection criteria comprising a weighted score value;
selecting the first item, when the first weighted score is higher than the second weighted score.

9. The system of claim 8, wherein the selecting comprises removing the second item from a database.

10. The system of claim 1, wherein the recommendation comprises a first indication to store the first item in a database and/or a second indication to remove the second item from the database.

11. A method comprising:
receiving, by a neural network, first textual data associated with a first item and second textual data associated with a second item;
converting, by the neural network, the first textual data to a first vector and the second textual data to a second vector, the first vector indicating one or more words associated with the first item, the second vector indicating one or more words associated with the second item;
determining, by the neural network, whether the first item and the second item satisfy, based on a comparison of the first vector with the second vector, a similarity threshold;
selecting, by the neural network and in response to satisfaction of the similarity threshold, one of the first item and the second item, the selecting based on a selection criteria; and
providing, by the neural network, a recommendation on a user interface regarding the selected first item or second item.

12. The method of claim 11, wherein the receiving and the converting are performed by an input layer of the neural network, wherein the determining is performed by an embedding layer of the neural network, and wherein the selecting and the providing are performed by a comparison layer of the neural network.

13. The method of claim 11, wherein the operations further comprise preprocessing the first textual data and/or the second textual data to remove at least a portion of the first textual data and/or the second textual data.

14. The method of claim 11, wherein the converting comprises training a word embedding model and converting the first textual data to the first vector and the second textual data to the second vector using the trained word embedding model.

15. The method of claim 11, wherein the determining comprises:
comparing, in response to receiving the first and the second vectors, the one or more words associated with the first item and the one or more words associated with the second item; and
determining, based on the comparing the one or more words associated with the first item and the one or more words associated with the second item, a degree of similarity between the first item and the second item, wherein the similarity threshold comprises a threshold degree of similarity value.

16. The method of claim 11, wherein the selection criteria comprises user-selected criteria.

17. The method of claim 11, wherein the selecting comprises:
correlating a first weighted score with the first item and a second weighted score with the second item, the selection criteria comprising a weighted score value;
selecting the first item, when the first weighted score is higher than the second weighted score.

18. The method of claim 17, wherein the selecting removing the second item from a database.

19. The method of claim 11, wherein the recommendation comprises a first indication to store the first item in a database and/or a second indication to remove the second item from the database.

20. A non-transitory computer program product storing instructions which, when executed by at least one data processor, causes operations comprising:
receiving, by a neural network, first textual data associated with a first item and second textual data associated with a second item;
converting, by the neural network, the first textual data to a first vector and the second textual data to a second vector, the first vector indicating one or more words associated with the first item, the second vector indicating one or more words associated with the second item;
determining, by the neural network, whether the first item and the second item satisfy, based on a comparison of the first vector with the second vector, a similarity threshold;
selecting, by the neural network and in response to satisfaction of the similarity threshold, one of the first item and the second item, the selecting based on a selection criteria; and
providing, by the neural network, a recommendation on a user interface regarding the selected first item or second item.
